(19) United States
(12) Patent Application Publication
(10) Pub. No.: US 2005/0126869 A1
(43) Pub. Date: Jun. 16, 2005

(54) Disk type brake structure

(76) Inventor: Te-Lung Yeh, Gueishan Township (TW)

Correspondence Address: TROXELL LAW OFFICE PLLC, SUITE 1404, 5205 LEESBURG PIKE, FALLS CHURCH, VA, 22041, US

(21) Appl. No.: 10/733,312

(22) Filed: Dec. 12, 2003

(51) Int. Cl. F16D 65/10

(52) U.S. Cl. 188/218 XL

(57) ABSTRACT

The present invention of a disk type brake structure comprises a friction section composed by superposing in the order of a first brake surface, a heat sink and a second brake surface on the outer periphery of the assembly section of the brake disk and, furthermore, several heat sink ribs in adequate height are mounted fixedly between the first brake surface of the said friction section and a heat sink as well as between the said heat sink and the second brake defining heat dissipation spaces with ventilating function between the first brake surface and the heat sink as well as between the heat sink and the second brake surface; such that temperature of the entire brake disk can be reduced rapidly to obviate overheat and deforming, and to prevent the brake disk from the danger of softening and brake loosing of the brake band caused by overheat.

### BACKGROUND OF THE INVENTION

1) Field of the Invention

The present invention of a disk type brake structure is to provide a brake disk structure possessing good ventilating gapping places at the friction section of the brake disk; under the requirements of different brake disk regulations, the base body of the brake disk can be formed as a friction section superposed by in the order of a first brake surface, a heat sink and a second brake surface, thereby the high temperature generated by braking can be transmitted through the heat sink holes formed by the first, the second brake surfaces and the heat sink ribs to the heat sink in the middle and provided with an efficient heat dissipation function by the heat sink.

2) Description of the Prior Art

Accordingly, the braking principle of the general vehicles mainly transfers the original kinetic energy of the rapid revolving of the wheel shaft to heat energy by the friction function and results in stopping the revolving wheel shaft; however, during the process while the wheel shaft comes to a stop from high speed revolving, the brake components of the vehicles not only need to possess quite a degree of heat resistance due to the function of energy transferring, but also need to have good heat dissipation effect among the brake components since the brake movement of the common vehicle is neither predictable nor conducted intermittently, for example, both the emergency brake under the situation of high speed traveling and the continuous brake operated on the slope can heat and deform the brake components due to the heat generated suddenly, furthermore, can cause the softening situation of the brake band due to the inefficient heat dissipation of the continuous high temperature thereby resulting in the wear of the brake components or even causing accident for failing to fulfill the original brake function.

### SUMMARY OF THE INVENTION

Therefore, the primary objective of the present invention is to provide a disk type brake structure mainly comprising a friction section composed by superposing in the order of a first brake surface, a heat sink and a second brake surface on the outer periphery of the assembly section of the brake disk; several heat sink ribs in adequate height are mounted fixedly between the first brake surface of the said friction section and the heat sink as well as between the said heat sinks and the second brake defining heat dissipation spaces with ventilating function between the first brake surface and the heat sink as well as between the heat sink and the second brake surface; therefore, when the first and the second brake surfaces generate high temperature due to the braking friction, not only the temperature can be dissipated outward through the heat sink holes formed by the first, the second brake surfaces and the heat sink ribs, the excess temperature can also be transmitted to the middle heat sink, and efficient heat dissipation function can be provided by the heat sink thereat.

Another objective of the present invention of a disk type brake structure is, in addition to have heat dissipation spaces with ventilating function between the first brake surface and the heat sink as well as between the heat sink and the second brake surface, the first brake surface, the heat sink and the second brake surface can be integrated into a friction section with relative strength of structure.

### BRIEF DESCRIPTION OF THE DRAWINGS

FIG. 1 is an external view drawing of the structure of a preferred exemplary embodiment of the present invention.

FIG. 2 is a lateral view drawing of the present invention and a schematic drawing of the heat dissipation status.

FIG. 3 is a schematic drawing of another preferred exemplary embodiment of the present invention.

FIG. 4 is a schematic drawing of yet another preferred exemplary embodiment of the present invention.

### DETAILED DESCRIPTION OF THE PREFERRED EMBODIMENTS

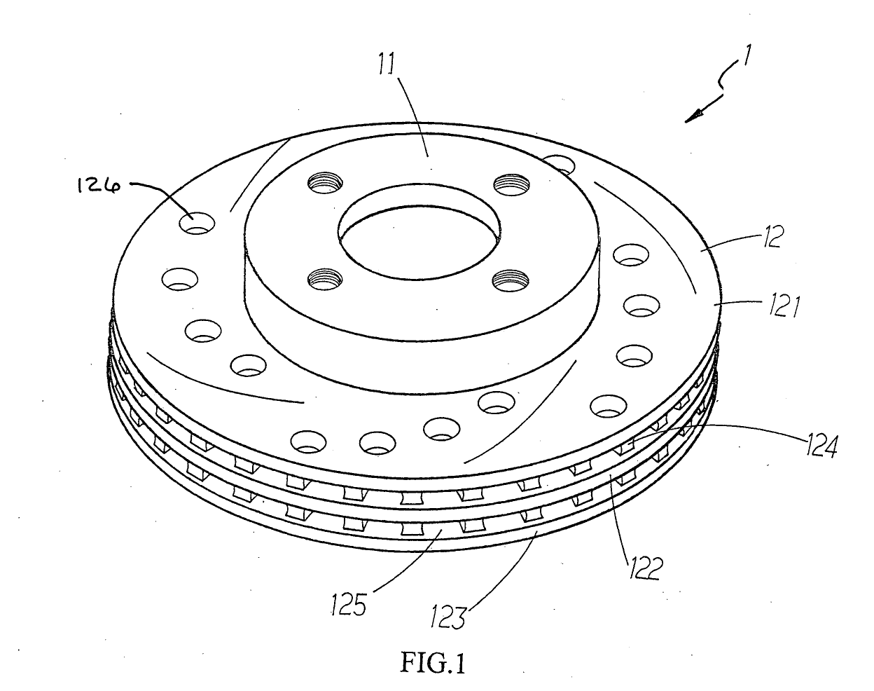

The present invention of a disk type brake structure, the base body structure of its brake disk is shown in FIG. 1; the base body of the brake disk (1) is a circular disk structure with good heat dissipation effect, the inner assembly surface (112) of its assembly section (11) can be assembled and conjoined with the wheel hub on the wheel shaft, a friction section (12) is situated on the two outer peripheral sides of the assembly section (11) for forming friction resistance function with the brake band, wherein the friction section (12) is composed by superposing in the order of a first brake surface (121), a heat sink (122) and a second brake surface (123), several heat sink ribs (124) in adequate height are disposed fixedly between the first brake surface (121) and the heat sink (122) as well as between the heat sink (122) and the second brake surface (123); the entire structure utilizes the heat sink ribs (124) to integrate the first brake surface (121), the heat sink (122) and the second brake surface (123) into a friction section (12) of relative strength of structure and to define proper heat sink holes (125) between the first brake surface (121) and the heat sink (122) as well as between the heat sink (122) and the second brake surface (123).

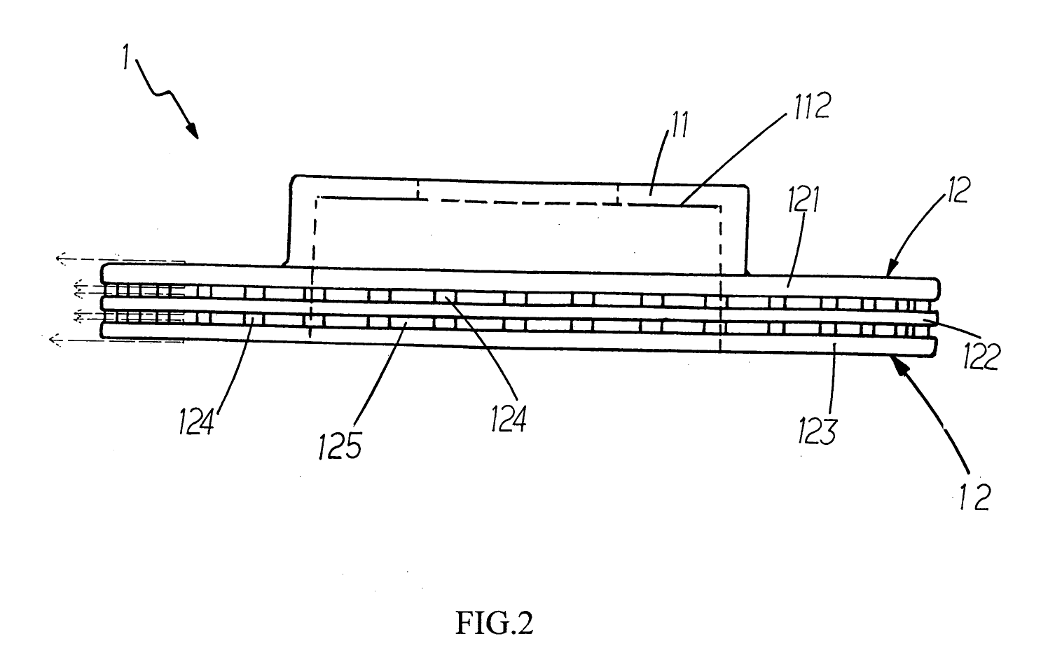

Referring also to FIG. 2, since the friction section (12) used by the brake disk (1) of the present invention for forming friction resistance function with the brake surfaces is in a structural state of having the first brake surface (121) and the second brake surface (123) clamped a heat sink (122) with adequate bay; wherein the superposed and composed structural state, the first brake surface (121), the second brake surface (123) and a heat sink (122) are connected by several heat sink ribs (124), furthermore, several heat sink holes (125) are formed among the first brake surface (121), the second brake surface (123) and the heat sink (122); therefore, when the vehicle is braking, the high temperature generated by friction not only can be dissipated outward through the heat sink holes (125) formed by the first, the second brake surfaces (121, 123) and the heat sink ribs (124), the excess temperature can also be transmitted to the middle heat sink (122), and efficient heat dissipation function is provided by the heat sink (122) thereat, such that the temperature of the first and the second brake surfaces (121, 123) on two sides can be reduced rapidly to obviate overheat and deforming, furthermore to prevent the brake disk (1) from the danger of softening and brake loosing of the brake band caused by overheat; more especially, the entire brake disk structure allows the practical increasing of decreasing of the number of the heat sinks between the first brake surface and the second brake surface according to the permitted specific dimension regulation for producing more efficient heat dissipation.

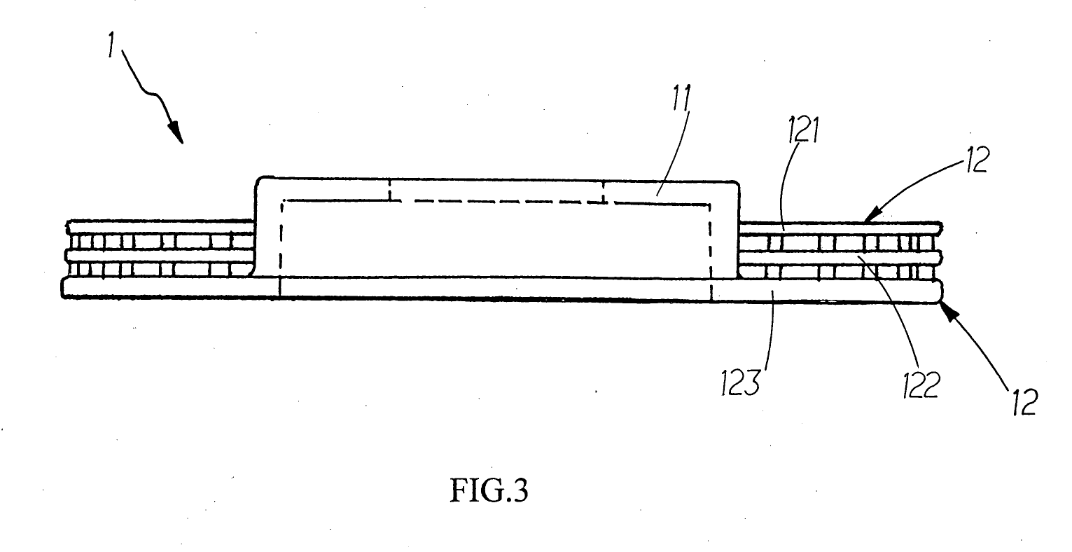

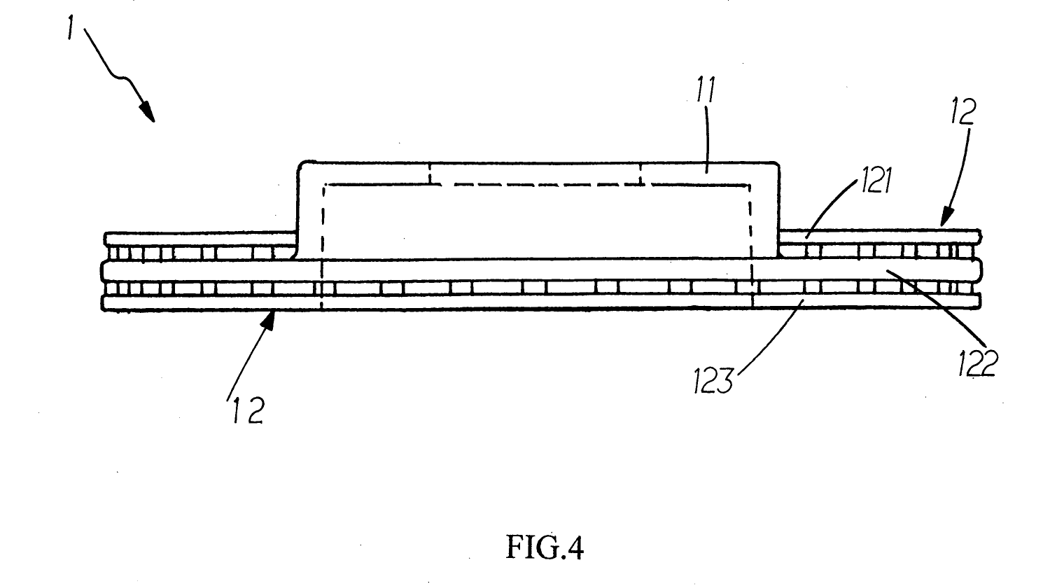

Furthermore, referring also to FIGS. 2, 3 and 4, as indicated, most basically, the present invention is embodied exemplarily by the structural state of disposing a heat sink (122) between the first and the second brake surfaces (121, 123); the entire brake disk (1) structure is capable of facilitating the manufacturing and maintaining the required strength of structure; as shown in FIG. 2, the assembly section (11) can be molded into one unit with the first brake surface (121), or as shown in FIG. 3, the assembly section (11) can be molded into one unit with the second brake surface (123), and as shown in FIG. 4, the assembly section (11) and the heat sink (122) can also be molded into a structural form of one unit.

The present invention of a disk type brake structure utilizes a friction section composed by superposing in the order of a first brake surface, a heat sink and a second brake surface on the outer periphery of the assembly section of the brake disk and, furthermore, several heat sink ribs in adequate height are mounted fixedly between the first brake surface of the said friction section and the heat sink as well as between the said heat sink and the second brake not only defining a friction section of relative strength of structure but also make the friction section possess heat dissipation spaces with ventilating function for providing efficient heat dissipation to rapidly reduce the temperature of the entire brake disk in order to obviate overheat and deforming and further to prevent the brake disk from the danger of softening and brake loosing of the brake band caused by overheat. The present invention provides the disk type brake with another preferred and feasible structure and is hereby submitted lawfully to the patent bureau for review and the granting of the commensurate patent rights.

1-6. (canceled)

7. A disk brake structure comprising:
a) an assembly section;
b) a friction section connected to the assembly section and having:
i) a first brake surface;
ii) a second brake surface;
iii) a heat sink located between the first brake surface and the second brake surface; and
iv) a plurality of heat sink ribs located between and connecting the heat sink to the first brake surface and the heat sink to the second brake surface, the plurality of heat sink ribs being spaced apart a predetermined distance; and
c) a plurality of heat sink holes located in a structure selected from the group consisting of the first brake surface, the second brake surface, the heat sink, and a combination thereof, wherein a predetermined number of the plurality of heat sink holes form a plurality of curved patterns, each of the plurality of curved patterns having a first end located adjacent a inner periphery of the friction section and a second end located adjacent to an outer periphery of the friction section.

8. The according to claim 7, wherein the assembly section and the first brake surface are molded as a single unit.

9. The according to claim 7, wherein the assembly section and the second brake surface are molded as a single unit.

10. The according to claim 7, wherein the assembly section and the heat sink are molded as a single unit.
